(19) United States
(12) Patent Application Publication
(10) Pub. No.: US 2026/0170140 A1
(43) Pub. Date: Jun. 18, 2026

(54) SYSTEM AND METHOD FOR LOADING A CORRECTIVE CODE

(71) Applicant: STMicroelectronics International N.V., Geneva (CH)

(72) Inventors: Lionel Debieve, Fille (FR); Loic Pallardy, Rouillon (FR); Mark Trimmer, Coublevie (FR); Eric Sagnard, LE CANNET (FR); Asma Mkhinini, Antibes (FR)

(21) Appl. No.: 19/417,110

(22) Filed: Dec. 11, 2025

(30) Foreign Application Priority Data
Dec. 18, 2024 (FR) 2414429

(51) Int. Cl. G06F 21/57; G06F 21/60; G11C 17/18

(52) U.S. Cl. CPC G06F 21/572; G06F 21/602; G11C 17/18

(57) ABSTRACT

The present description concerns a method of loading code into a system and the associated system. In a first state of the system, the encrypted code is written into a volatile memory via a programming port. In a second state of the system, the encrypted code is loaded into a first circuit, where it is decrypted before being written into a one-time programmable memory. The system then switches to a third state. The one-time programmable memory area is programmable only by the first circuit and only in the second state.

### CROSS-REFERENCE TO RELATED APPLICATIONS

This application claims priority to French Application No. 2414429, filed on Dec. 18, 2024, which application is hereby incorporated herein by reference.

### TECHNICAL FIELD

The present disclosure generally concerns electronic systems and methods, and more particularly to a system and method of loading a corrective code (“patch code”) for a read-only memory of such an electronic system.

### BACKGROUND

Many known electronic systems comprise at least a processor and a read-only memory (ROM) containing code executable by the processor.

When the code stored in the read-only memory contains one or more errors, the content of the read-only memory cannot be modified to correct this or these error(s).

Various solutions have been provided to supply the electronic system with a patch code, the latter for example being stored in a non-volatile memory of the system.

However, these known solutions have disadvantages.

### SUMMARY

There is a need for a method of loading a patch code into an electronic system which overcomes all or part of the disadvantages of known solutions for supplying a patch code to an electronic system, when this patch code is intended to correct one or more errors in a code stored in a read-only memory of the system.

There is also a need for an electronic system which overcomes all or part of the disadvantages of known electronic systems configured to receive a patch code, when this patch code is intended to correct one or more errors in code stored in a read-only memory of the system.

An embodiment overcomes all or part of the disadvantages of known solutions for supplying a patch code to an electronic system, when the patch code is intended to correct one or more errors in a code stored in a read-only memory of the system.

An embodiment overcomes all or part of the disadvantages of known electronic systems configured to receive a patch code intended to correct one or more errors in a code stored in a read-only memory of the system.

An embodiment provides a method of loading a patch code into an electronic system comprising: a one-time programmable memory area; a first circuit; a first read-only memory having first instructions stored therein; a volatile memory area configured to retain its data on resetting of the system; a first processor; and an external programming port, the method comprising:
in a first state of the system, writing the encrypted patch code into the volatile memory area with the programming port, controlling a switching of the system to a second state at the next reset, and resetting the system;
in the second state, at the starting of the system, executing the first instructions with the first processor, the execution causing:
an access to the volatile memory area to check whether the encrypted patch code is present therein,
a command to switch the system to a third state at the next reset, and a resetting of the system if the encrypted patch code is absent from the volatile memory area, and
a loading of the encrypted patch code into the first circuit if the encrypted patch code is present in the volatile memory area;
in the second state, as a response to the loading of the encrypted patch code into the first circuit:
decrypting the encrypted patch code received by the first circuit, with the first circuit and a decryption key stored in the first circuit, and
writing with the first circuit the decrypted patch code into the one-time programmable memory area; and
in the second state, as a response to an end of loading of the decrypted patch code into the one-time programmable memory area, controlling a switching of the system to the third state at the next reset and resetting the system. The one-time programmable memory area is programmable only by the first circuit and only in the second state.

According to an embodiment, a transition from the second state to the first state is prohibited.

According to embodiment, a transition from the third state to any of the first and second states is prohibited.

According to an embodiment, a programming of the volatile memory area with the external port is prohibited in the second and third states.

According to an embodiment, an execution of the first instructions is prohibited in the first and third states.

According to an embodiment, the patch code is encrypted outside the system with an encryption key known only to the system manufacturer.

According to an embodiment:
the encrypted patch code is encapsulated in a structure comprising the encrypted patch code and a first validity code calculated outside the system on the encrypted patch code;
the structure is stored in the volatile memory area on writing of the encrypted patch code into the volatile memory area; and
the loading of the encrypted patch code into the first circuit is conditional on an equality between the first validity code and a second validity code calculated in the system on the encrypted patch code stored in the volatile memory area.

According to an embodiment:
the encrypted patch code comprises a validity code calculated outside the system on the patch code prior to its encryption; and
at the end of the loading of the decrypted patch code into the one-time programmable memory area, the controlling of the switching of the system to the third state and the resetting of the system are conditional on an equality between the validity code calculated outside the system on the patch code prior to its encryption and a validity code calculated in the system on the decrypted patch code present in the one-time programmable memory area.

According to an embodiment, the encrypted patch code comprises one or more error corrections, each error correction comprising a memory address and corrected data for replacing erroneous data stored at the memory address.

According to an embodiment:
for each error correction, the patch code comprises a duplicate of the memory address and a duplicate of the corrected data; and
the writing of each error correction into a one-time programmable memory area after decryption by the first circuit is conditional on an equality between the memory address and the duplicate of the memory address and between the corrected data and the duplicate of the corrected data.

According to an embodiment:
the loading of the encrypted patch code into the first circuit is carried out error correction by error correction; and
the decryption of the encrypted patch code with the first circuit comprises, after each reception of an encrypted error correction, the decryption of the error correction.

According to an embodiment, the system comprises at least a second processor and at least a second read-only memory.

According to an embodiment, each error correction further comprises an indication of the read-only memory of the system to which the error correction applies.

According to an embodiment, the first processor and the first read-only memory are more secure than the at least one second processor and the at least one second read-only memory, the first instructions being only executable by the first processor.

Another embodiment provides an electronic system comprising:
a one-time programmable memory area;
a volatile memory area configured to retain its data on resetting of the system;
an external programming port adapted to writing into the volatile memory area in a first state of the system;
a read-only memory having first instructions stored therein;
a first circuit configured, when the system is in a second state and an encrypted patch code is loaded into the first circuit, to decode the patch code and to write the decrypted patch code into the one-time programmable memory area; and
a first processor configured, at the starting of the system in the second state, to read and execute the first instructions, the first instructions being configured to cause access to the volatile memory area to check whether the encrypted patch code is present therein, and a loading of the encrypted patch code into the first circuit if the encrypted patch code is present in the volatile memory area. The system is configured:
to switch from the second state to a third state after the writing of the decrypted patch code into the one-time programmable memory area;
to switch from the second state to the third state if no encrypted patch code is present on access to the volatile memory area;
so that the one-time programmable memory area is programmable only by the first circuit and only in the second state.

According to an embodiment, the system is further configured:
to prohibit a switching from the second state to the first state;
to prohibit a switching from the third state to any of the first and second states;
to prevent a programming of the volatile memory area with the port in the second and third states;
to prohibit access to the first instructions in the first and third states.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows, in the form of blocks, an example of an electronic system configured to receive a patch code for a code stored in a read-only memory of the system;

FIG. 2 shows, in the form of blocks, an embodiment of an electronic system configured to receive a patch code for a code stored in a read-only memory of the system;

FIG. 3 shows, the form of a flowchart, an embodiment of a method of loading a patch code into the electronic system of FIG. 2;

FIG. 4 shows, in the form of blocks, an alternative embodiment of the electronic system of FIG. 2;

FIG. 5 shows, in the form of a flowchart, a detailed example of implementation of a step of the method of FIG. 3; and

FIG. 6 shows, in the form of a flowchart, an example of a detail of the implementation of still another step of the method of FIG. 3.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

In the rest of the present disclosure, unless otherwise specified, the expression “a memory” designates a memory circuit comprising a data storage space and circuits controlling the access to this data storage space. Further, the expression “a memory area” designates all or part of a data storage space not necessarily forming part of a memory. In particular, the storage space of a memory may be divided into a plurality of memory areas, and the rights and conditions of access to these memory areas may be different between two memory areas.

FIG. 1 shows in block form an example of an electronic system 1 configured to receive a patch code for a code stored in a read-only memory of the system.

System 1 comprises a processor μC1 and a read-only memory ROM1 associated with processor μC1. Further, system 1 includes a communication structure 104, for example one or a plurality of communication buses, configured to ensure data exchanges between the elements of system 1, for example between processor μC1 and memory ROM1.

Usually, memory ROM1 comprises a memory area Mem where code intended to be executed by processor μC1 is stored. Memory ROM1 further comprises a memory controller Ctrl. Memory controller Ctrl is, for example, configured to receive requests for accessing in read mode to memory ROM1, and to respond by returning a digital word stored in memory area Mem of memory ROM1 at the address corresponding to the read access request.

When the code stored in memory ROM1 contains an error, a patch code may be loaded into system 1.

For this purpose, system 1 comprises a port 100 for programming system 1 from outside the system. System 100 further comprises a non-volatile memory area 102 (“Patch mem” in FIG. 1), into which the patch code is loaded from the outside, via port 100. For example, port 100 is a JTAG-type port. For example, port 100 and memory area 102 are coupled to each other via structure 104.

If a read access to memory ROM1 is requested at an address corresponding to erroneous data, and a patch code corresponding to this address and comprising corrected data has been stored in memory area 102, system 1, for example memory controller Ctrl, is configured so that the data sent to structure 104 as a response to the read access is the corrected data contained in the patch code, and not the erroneous data stored in memory ROM1. Thus, system 1 operates as if the erroneous data stored in memory ROM1 had been replaced by the corrected data.

However, although the possibility of loading a patch code for code stored in the memory ROM1 of system 1 is advantageous, this raises various issues.

Indeed, the code stored in memory ROM1 generally comprises functions that must not be modified by a user of the system, for example when these functions concern the safety of system 1.

Further, the loading of the patch code into memory area 102 is usually implemented by executing a number of instructions stored in memory ROM1, which raises an issue when memory ROM1 contains one or more errors that the patch code precisely aims at correcting. Indeed, in this case, the loading of the patch code into memory area 102 may be impossible.

It would thus be desirable to have an electronic system and a method of loading a patch code into this electronic system in which only the system manufacturer, that is, the programmer of the read-only memory or memories of the system, is capable of loading a patch code into the system to correct one or more errors present in these read-only memories.

It would also be desirable to have an electronic system and a method of loading a patch code into this electronic system in which, once a patch code for the read-only memory or memories of the system has been loaded into the system, this patch code can no longer be modified and no further patch code can be loaded into the system. Indeed, this enables to implement a step of certification of the code stored in the read-only memory or memories of the system and of the patch code loaded into the system seen as a whole.

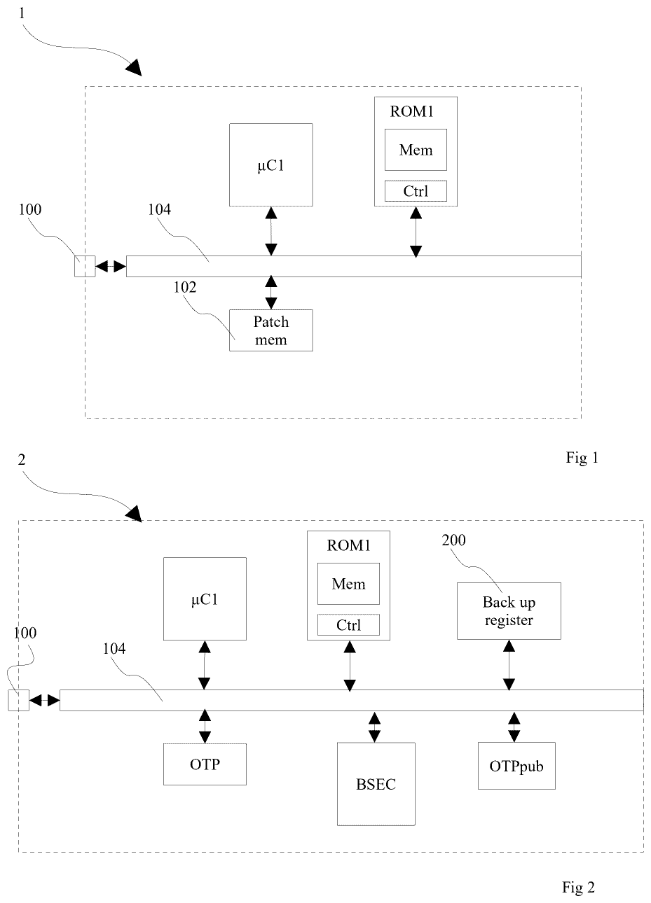

FIG. 2 shows in the form of blocks an embodiment of an electronic system 2 configured to receive a patch code for a code stored in a read-only memory of system 2.

Electronic system 2 comprises, like system 1, an external programming port 100, a processor μC1, a read-only memory ROM1, and a communication structure 104 called bus 104 in the rest of the disclosure.

System 2 further comprises circuits (not shown in FIG. 2) enabling to define a security state of system 2. The current security state of system 2 indicates at what point in its lifecycle the system is. Further, depending on its current security state, certain functionalities of system 2 are authorized or, on the contrary, prohibited. As an example, the current security state of the system can only be changed to a next security state, and cannot be changed to a previous security state of the system. In other words, the current security state of the system can only take values increasing from an initial value, for example, equal to 1.

System 2 further comprises an OTP (One Time Programmable) memory area. The OTP memory area is intended to receive a patch code for code stored in read-only memory ROM1. The OTP memory area may be part of a one-time programmable memory comprising other areas, for example an area intended to store the current security state of the system.

System 2 further comprises a circuit BSEC. Circuit BSEC is configured to write, that is, to program, the OTP memory area intended to receive a patch code for the code programmed in memory ROM1. More particularly, this OTP memory area can only be programmed by circuit BSEC.

Circuit BSEC and the OTP memory area are, for example, coupled to each other via bus 104.

System 2 further comprises a volatile memory area, for example a RAM memory, 200 (“back-up register” in FIG. 2). Although volatile, memory 200 is configured to retain its data during a system reset step, for example, a reset step implemented to update the security state of the system. Memory area 200 is, for example, configured to receive a patch code via port 100, so that this code is stored therein before being written (or programmed) by circuit BSEC into the OTP memory area intended for this purpose.

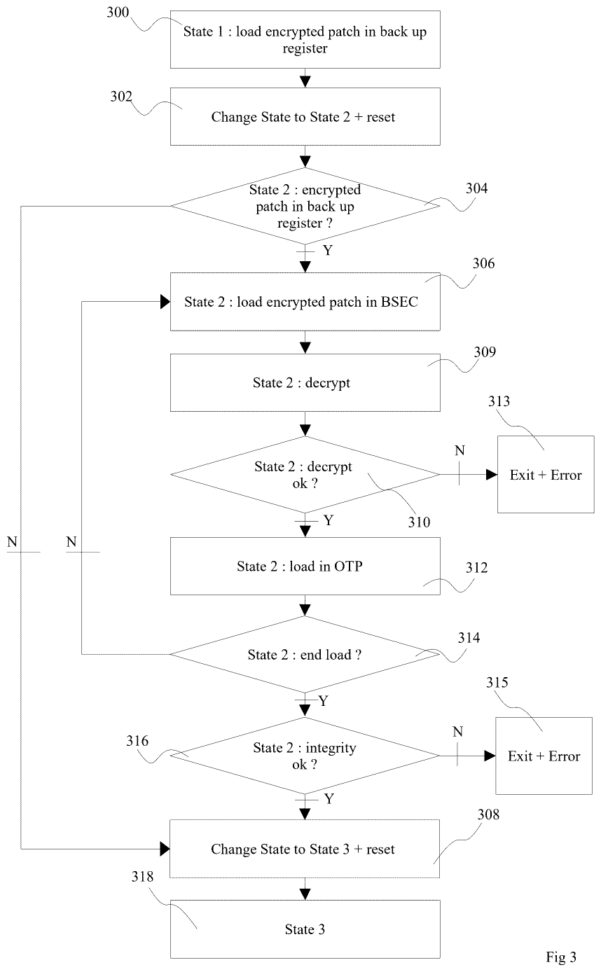

Further, in system 2, instructions, called first instructions hereafter, are present (or recorded or stored) in memory ROM1. These first instructions are executed, as will be described in more detail in relation with FIG. 3, when a patch code is loaded into system 2. However, as will be described in more detail in relation with FIG. 3, as compared with a system 1 in which the loading of a patch code into memory area 102 essentially relies on the execution, by the processor μC1 of system 1, of second instructions present in the memory ROM1 of system 1, the number of first instructions in system 2 is smaller than the number of second instructions in system 1. This enables to decrease the need to use memory ROM1 to load patch code into the system. In other words, this enables to decrease the likelihood for the loading of the patch code to be impossible because it calls up code that is present in memory ROM1 and exhibits one or more errors.

System 2 may further comprise many other circuits, memories or memory areas which are not shown in FIG. 2. For example, system 2 comprises a one-time programmable memory area OTPpub, which is, for example, part of a one-time programmable memory comprising the OTP memory area.

The operation of system 2 on loading of a patch code into system 2 will now be described in more detail in relation with FIG. 3.

FIG. 3 shows, in the form of a flowchart, an embodiment of a method of loading a patch code into the electronic system 2 of FIG. 2.

At a step 300 (“State 1: load encrypted patch in back up register” in FIG. 3), the system is in a first security state, or, in other words, the current security state of the system is the first security state. In this first security state of system 2, a patch code can be loaded into system 2 from the outside.

In this first security state, the port 100 of system 2 is open, and it is possible to load (or write) data, for example a patch code, into memory area 200 via port 100.

When a patch code is loaded into memory 200, via port 100, from outside system 2, this patch code is encrypted. For example, the encryption of the patch code is implemented by the manufacturer of system 2, outside system 2, by means of an encryption key known only to them. The corresponding decryption key is present (or stored) in system 2, preferably in circuit BSEC.

In the first security state, the programming by circuit BSEC of the OTP memory area intended to receive a patch code is prohibited. This enables to prevent circuit BSEC from programming this OTP memory area with anything other than the patch code supplied by the manufacturer to system 2.

Further, in the first security state, the access to the first instructions in memory ROM1 is prohibited, so that processor μC1 cannot execute these first instructions. This enables to prevent port 100 from being used to read sensitive or secret information stored in memory ROM1.

As an example, the first security state of system 2 in which port 100 is open enables, in addition to the possibility of loading an encrypted patch code into memory 220, to implement tests in system 2 to verify its functionality after manufacturing of system 2 and/or to program bits for configuring system 2 via port 100.

Preferably, system 2 always passes through the first security state, that is, through step 300, whether or not an encrypted patch code is loaded into memory 200 from the outside via port 100 when system 2 is in this first security state. In other words, in the case of a system 2 not requiring receiving a patch code from the code stored in the read-only memory, the step of loading of a patch code into memory 200 is omitted, but the step 300 where the system is in the first security state is preferably implemented to enable the testing of the system and/or the programming of configuration bits of system 2.

Once step 300 has been completed, whether or not an encrypted patch code has been stored in memory 200 via port 100, in a subsequent step 302 (“Change State to State 2+reset” in FIG. 3), system 2 is controlled to switch to a second security state at the next resetting, and is then reset. For example, this request to switch from the first to the second security state and this reset are controlled via port 100.

After the resetting of system 2 at step 302, the system starts in the second security state at a subsequent step 304 (“State 2: encrypted patch in back up register?” in FIG. 3).

In the second security state, the programming of memory area 200 via port 100 is prohibited. Thus, the encrypted patch code that was loaded into memory area 200 at step 300 and retained in this memory area 200 on resetting of system 2 at the end of step 302 cannot be modified from the outside via port 100.

In the second security state, circuit BSEC has the ability, or, in other words, the authorization, to program the OTP memory area which is dedicated to the storage of a patch code. More particularly, circuit BSEC is only authorized to program the OTP memory area dedicated to the storage of a patch code in this second security state.

Further, in the second security state, the first instructions stored in memory ROM1 are accessible to processor μC1. Thus, at the starting of system 2 in the second security state, that is, at the beginning of step 304, processor μC1 reads and executes the first instructions in memory ROM1. These instructions are few in number, and their execution causes the implementation of very simple functions.

More particularly, the execution of these first instructions by processor μC1 causes an access to memory area 200 to check whether or not an encrypted patch code has been loaded therein prior to step 304.

If there is no encrypted patch code present in memory area 200 (output N of block 304), the method continues at a next step 308 (“Change State to State 3+reset” in FIG. 3).

Conversely, if an encrypted patch code is present in memory area 200 (output Y of block 304), the method continues at a subsequent step 306 (“State 2: load encrypted patch in BSEC” in FIG. 3).

At step 306, the execution of the first instructions by processor μC1 causes the loading into circuit BSEC, for example into internal registers of circuit BSEC, of the encrypted patch code present in memory area 200. At step 306, the system is still in the second security state.

Step 306 is followed by a step 309 (“State 2: decrypt”). This step is implemented by circuit BSEC, and not by the execution of first instructions stored in memory ROM1, which limits the number of first instructions required for the implementation of the loading of a patch code into system 2. At step 309, the system is still in the second security state.

At step 309, circuit BSEC decrypts the encrypted patch code that it has just received. For this purpose, circuit BSEC comprises a decryption key hard-coded into circuit BSEC. As an example, the encryption of the patch code prior to its loading into memory area 200 via port 100 and the decryption of the patch code encrypted by circuit BSEC use an asymmetric encryption algorithm, for example of AES type. As an example, circuit BSEC comprises a circuit adapted to implementing the decryption of the encrypted patch code with the decryption key stored in circuit BSEC.

Once the decryption of the code received at step 306 has been completed, the method continues at an optional step 310 (“State 2: decrypt ok?), or directly at a step 312 (“State 2: load in OTP” block in FIG. 3) if step 310 is omitted.

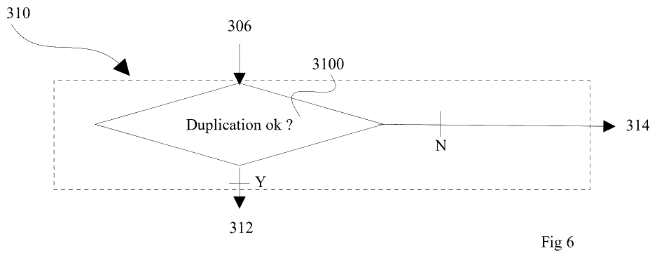

At step 310, circuit BSEC checks whether the result of the decryption is correct. An example of implementation of this step will be described later, in relation with FIG. 6.

If the result of the decryption is correct (output Y of block 310), the method continues at step 312.

However, if the patch code is incorrect (output N of block 310), this signifies that the patch code has been corrupted, intentionally or not, with respect to the original patch code. In this case, the method continues to a step 313 (“Exit+Error” in FIG. 3) where the loading of the patch code into system 2 is interrupted and, preferably, an error message is sent to the outside of system 2 to warn of this corruption of the patch code. Once at step 313, system 2 is blocked and can no longer proceed to any other method step. System 2 is then unusable.

At step 312, while system 2 is still in the second security state, circuit BSEC programs the OTP memory area with the patch code decrypted at the previous step 309.

According to a first embodiment, at step 306, all the encrypted patch code is loaded from memory 200 into circuit BSEC. In this case, step 309, optional step 310, and step 312 are, for example, implemented over all the patch code.

In this first embodiment, step 312 is then followed by an optional step 316 (block “State 2: integrity OK”), or by step 308 if step 316 is omitted.

However, according to a second embodiment, in order to reduce memory requirements in circuit BSEC, at step 306, only a portion of the encrypted patch code is loaded into circuit BSEC from memory 200. In this case, step 309 is implemented only on this portion of the encrypted patch code, optional step 310 is implemented on the result of the decryption of this encrypted patch code portion, and step 312 consists of loading into the OTP memory area the result of the decryption of the encrypted code portion received by circuit BSEC at step 306. Then, as long as all the encrypted code portions have not been received by circuit BSEC, decrypted by circuit BSEC, and written into the OTP memory area by circuit BSEC once decrypted, step 312 loops back to step 306 to process the next encrypted patch code portion. As an example, when the encrypted patch code comprises a plurality of error corrections, each portion of encrypted patch code loaded into circuit BSEC at step 306 corresponds to an error correction.

FIG. 3 illustrates this second embodiment. Thus, in FIG. 3, step 312 is followed by a step 314 (block “end load?” in FIG. 3). At step 314, system 2, for example circuit BSEC or processor μC1, checks whether all the encrypted code portions have been loaded into circuit BSEC from memory 200, to be decrypted therein and written into the OTP memory area.

If this is not the case (output N of block 314) and there remains a portion of the encrypted code stored in memory 200 to be transferred, then step 314 is followed by step 306, which is implemented for the next encrypted code portion.

If this is the case (output Y of block 314), step 314 is followed by an optional step 316 (block “State 2: integrity ok?”), or by step 308 if optional step 316 is omitted.

At step 316, processor μC1, for example via the execution of the first instructions present in memory ROM1, or circuit BESC checks that the decrypted patch code which is now present in the OTP memory area has not been corrupted with respect to the patch code that was encrypted outside system 2.

If the patch code has been corrupted (output N of block 316), the process continues at a step 315 (block “Exit+Error”) similar to step 313. Otherwise (output Y of block 316), the method continues at step 308.

According to an embodiment, prior to its encryption outside system 2, a validity code Crc1, for example a checksum, is calculated on the still unencrypted patch code. This validity code is encrypted at the same time as the patch code, whereby the encrypted patch code which is loaded into memory area 200 at step 300 comprises the encrypted validity code Crc1.

In such an embodiment, when circuit BSEC decodes the patch code encrypted at step 309, it obtains the validity the code Crc1 calculated outside system 2 on the initial unencrypted patch code, and this validity code Crc1 is stored in a memory area, for example in memory area OTPpub.

Preferably, when the code Crc1 calculated outside system 2 is stored in a non-volatile one-time programmable memory, system 2 checks whether the memory location where this validity code Crc1 is to be stored is effectively empty. If this is the case, the method continues and code Crc1 is stored. On the other hand, if this is not the case, this means that this step of storing the validity code Crc1 originating from outside the system has already been implemented once, and, for example, that system 2 has since been reset. In this case, the method is interrupted, and an error message is sent to the outside of system 2.

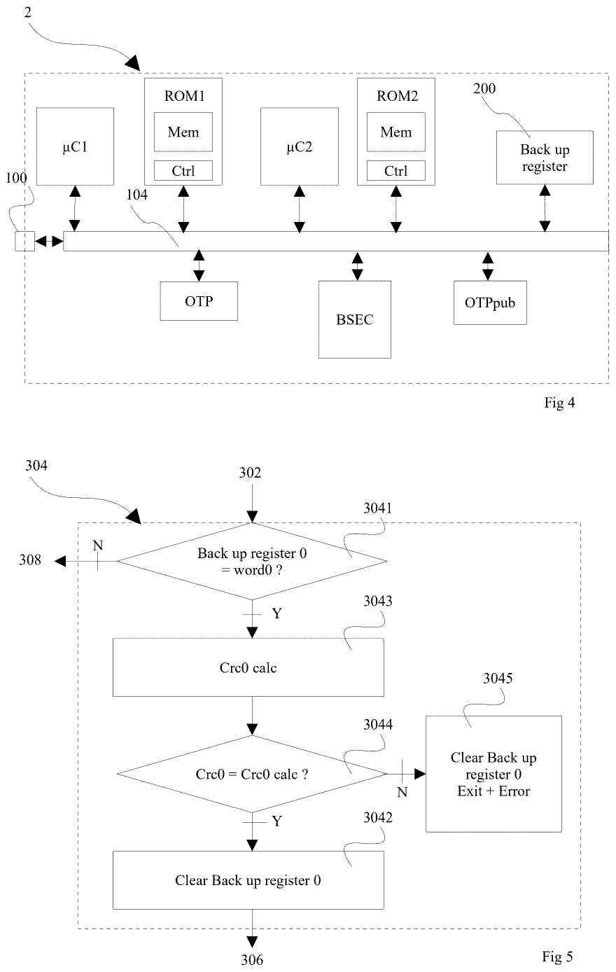

In the case where the encrypted patch code comprises the validity code Crc1 calculated outside system 2, step 316 (FIG. 4) can then be implemented as follows. Validity code Crc1 is recalculated on the decrypted patch code present in the OTP memory area, and this recalculated code Crc1 is then compared with the validity code Crc1 that was present in the encrypted patch code stored in memory area 200. If these two validity codes are identical, step 316 is completed and the method continues at step 308. If not, this means that the decrypted patch code present in the OTP memory area is not identical to the original patch code that was encrypted outside system 2, and the method continues at step 315. As an example, the calculation of validity code Crc1 on the patch code present in the OTP memory area and its comparison with the validity code Crc1 present in the encrypted patch code stored in memory area 200 results from the execution, by processor μC1, of the first instructions present in memory ROM1. As an alternative example, this calculation and this comparison are implemented by circuit BSEC.

At step 308, system 2 is controlled to switch from the second security state to a third security state at the next resetting, and is then reset.

At a step 318 (“State 3” in FIG. 3) following step 308, system 2 starts up in the third state.

In this third security state, memory area 200 cannot be programmed by port 100 or system 2 itself, in other words, memory 200 can no longer be programmed. Further, the first instructions of memory ROM1 can no longer be accessed, which makes the execution of these first instructions prohibited or impossible. Finally, in the third state, circuit BSEC can no longer program the OTP memory area dedicated to the storage of a patch code.

Further, as already mentioned hereabove, system 2 is designed in such a way that the transition of system 2 from the third state to the second state or the first state is prohibited, and the transition from the second state to the first state is prohibited.

As a result, once system 2 is in the third state, it is no longer possible to load a patch code into system 2. Nor is it possible to modify a patch code stored in the OTP memory area.

Preferably, in all other security states of system 2 subsequent to the third security state, the programming of memory area 200 is prohibited, the programming of the OTP memory area intended for storage of a patch code by circuit BSEC is prohibited, and the execution of the first instructions stored in memory ROM1 is prohibited. Thus, once the patch code has been loaded into the OTP memory area, it can no longer be modified. In other words, the programming of the OTP memory area intended for the storage of a patch code is only possible when system 2 is at state 2, and only by circuit BSEC.

The implementation of the method of FIG. 3 in the system 2 of FIG. 2 thus enables to load a patch code into the OTP memory area, while ensuring that this patch code originates from the manufacturer of system 2 due to the encryption/decryption implemented, and further enables to make sure that this patch code cannot be modified by a third party.

Further, the implementation of the method of FIG. 3 in system 2 enables to avoid creating security breaches in system 2 on loading of the patch code into system 2 and on subsequent use of system 2.

Optionally, once all the decrypted patch code has been written into the OTP memory area, the decryption key hard-coded in circuit BSEC is made permanently inaccessible or unusable.

Optionally, once all the decrypted patch code has been written into the OTP memory area, memory area 200 is made inaccessible or is erased, so that the encrypted patch code which is contained therein cannot be accessed by a third party.

From step 318, when system 2 starts up in the third state or in a state subsequent to the third state, system 2 checks whether there is a patch code stored in the OTP memory area. If a patch code is present in the OTP memory area, it comprises at least one error correction comprising, on the one hand, an address in memory ROM1 where erroneous data is stored and, on the other hand, corrected data intended to replace the erroneous data. System 2 then programs the controller Ctrl of memory ROM1, from the OTP memory area. Once programmed, controller Ctrl responds with the corrected data and not with the erroneous data when it receives a request for accessing this address in read mode.

Although this is not illustrated, as an example, the patch code before encryption comprises one or more error corrections. Each error correction comprises an address corresponding to erroneous data stored in a read-only memory of the system, for example in the memory ROM1 of system 2, and corrected data intended to replace the erroneous data.

Preferably, for each error correction, the patch code comprises a duplicate of the address and a duplicate of the corrected data, or, in other words, for each error correction, the patch code comprises the address and the duplicated address, as well as the corrected data and the duplicated corrected data. Thus, optionally, the writing of the patch code into the OTP memory area by circuit BSEC at step 312 may be conditional on the equality, for each error correction, between the address and the duplicated address, and between the corrected data and the duplicated corrected data. Thereby, if a modification is made to an error correction between the manufacturer's initial patch code and the patch code decrypted by circuit BSEC, this modification is detected by circuit BSEC and the correction is not stored in the OTP memory area.

Optionally, each error correction comprises a validity indication indicating whether the address/corrected data pair of the error correction is valid.

Optionally, each error correction comprises an indication of the read-only memory of the system to which the correction applies. Indeed, in a system with a plurality of read-only memories, this enables to correct errors in one or a plurality of read-only memories by implementing only once the method of FIG. 3, that is, by loading only one patch code into system 2, and using only one OTP memory area to store this patch code.

An example of such an alternative embodiment of system 2 is shown in FIG. 4.

The system 2 of FIG. 4 comprises the elements of the system 2 of FIG. 2, and further comprises at least another read-only memory and at least one other processor.

In the example of FIG. 4, system 2 comprises a single other memory ROM2 and a single other processor μC2.

According to an embodiment, in the system 2 of FIG. 4, processor μC1 and memory ROM1 are more secure than processor μC2 and memory ROM2. Further, the first instructions which are stored in memory ROM1 and which are executed by processor μC1 during the implementation of the method of FIG. 3 can only be accessed by the most secure processor, that is, processor μC1. In other words, the first instructions of memory ROM1 can only be executed by processor μC1, and more particularly only by processor μC1 when system 2 is in the second state. Preferably, when system 2 is in the second state and processor μC1 is executing the first instructions present in memory ROM1, processor μC2 is kept inactive, for example in a reset state, so as not to conflict with the steps implemented by processor μC1.

FIG. 5 shows, in the form of a flowchart, an example of a detail of the implementation of the step 304 of the method of FIG. 3.

In this example of implementation, according to an embodiment, during the writing of the encrypted patch code into memory area 200 at step 300 (see FIG. 3), a predetermined word “word0” is written into memory area 200, at an address “Back up register 0” in memory area 200. Step 304 then begins with a step 3041 (“Back up register 0=word0?” in FIG. 5), which consists in checking whether the word stored at address “Back up register 0” in memory area 200 effectively is the word “word0”. As an example, the implementation of this step 3041 results from the execution, by processor μC1, of the first instructions present in memory ROM1.

If this is not the case (output N of block 3041), then this signifies that no patch code has been loaded into memory area 200, or that what has been loaded into memory area 200 is not a legitimate patch code. Step 304 ends and the method continues at step 308 (see FIG. 3).

On the other hand, if this is the case (output Y of block 3041), then this means that a patch code has been loaded into memory area 204. As an example, step 304 is then completed and the method continues at step 306 (see FIG. 3). As an alternative example, step 3041 is followed by a step 3042 (“Clear back up register 0” in FIG. 5), during which the word stored at address “Back up register 0” in memory area 200 is erased before the end of step 304 and the continuation of the method at step 306. As an example, the implementation of this step 3042 results from the execution, by processor μC1, of the first instructions present in memory ROM1.

The provision of steps 3041 and 3042 during step 304 allows that, even if step 304 is unintentionally implemented for a second time, the second implementation of step 304 will not detect that a patch code is present in memory area 200. Thus, if the method is interrupted after step 304 and the encrypted patch code stored in memory area 200 is intentionally modified to create a security breach in system 2, this modified patch code will not be stored in the OTP memory area and will never be used by system 2.

According to an embodiment, during the step 300 of loading of the encrypted patch code into memory area 200, the encrypted patch code is encapsulated in a data structure comprising the encrypted patch code and a validity code Crc0 calculated on the encrypted patch code. This structure is built outside system 2. The validity code Crc0, for example a checksum, is calculated outside system 2 on the encrypted patch code. The loading of the encrypted patch code into memory area 200 at step 300 then comprises the loading of the entire data structure in which the encrypted patch code is encapsulated, and in particular of validity code Crc0. In such an embodiment, preferably, step 304 comprises a step 3043 (“Crc0 calc” in FIG. 5) during which validity code Crc0 is recalculated on the encrypted code stored in memory area 200. This step 3043 is followed by a step 3044 (“Crc0=Crc0 calc?” in FIG. 5), during which it is checked whether the validity code Crc0 which was calculated outside system 2 and then stored in memory area 200 with the encrypted patch code is equal to the validity code Crc0 calculated inside system 2 on the encrypted patch code stored in memory area 200. If this is the case (output Y of block 3044), step 304 continues and the method continues at step 306. If this is not the case (output N of block 3044), this means that the encrypted code stored in memory area 200 has been modified with respect to the corrective encrypted code supplied by the manufacturer. Step 304 is then interrupted at a step 3045 (“Clear Back up register 0 Exit+Error” in FIG. 5), consisting of interrupting the method and sending an error message outside system 2.

The provision of steps 3043 and 3044 enables to make the implementation of step 306, that is, the loading of the encrypted patch code from memory area 200 to circuit BSEC, conditional on an equality between the validity code Crc0 calculated outside system 2 on the encrypted code obtained as a result of the encryption implemented outside the system, and the code Crc0 calculated on the encrypted patch code stored in memory area 200. As an example, the implementation of steps 3043 and 3044 results from the execution, by processor μC1, of the first instructions present in memory ROM1.

In the example of FIG. 5, step 304 comprises steps 3041, 3042, and steps 3043, 3044, the latter being, for example, carried out between steps 3041 and 3042. In this case, preferably at step 3045, the word stored at address “Back up register 0” in memory area 200 is erased.

In another example not shown, where step 304 comprises steps 3041, 3042, 3043, and 3044, the order of these steps may be modified as compared with what is illustrated in FIG. 5.

In still another example, not shown, step 304 comprises steps 3043 and 3044, but does not comprise steps 3041 and 3042.

In still another non-illustrated example, step 304 comprises steps 3041 and 3042, but does not comprise steps 3043 and 3044.

Of course, the implementation of step 304 is not limited to the examples described hereabove in relation with FIG. 5. For example, step 304 may comprise a simple verification that memory area 200 is not empty to determine whether or not an encrypted patch code has been stored in memory area 200 at step 300.

FIG. 6 shows, in the form of a flowchart, an example of a detail of the implementation of step 310 of the method of FIG. 3.

In the example of FIG. 6, an embodiment in which the patch code available outside the system comprises, for each error correction, a duplication of the address and of the corrected data corresponding to this error correction, is considered. Step 310 then comprises a step 3100 (“Duplication ok?” in FIG. 6) which consists in checking, for each error correction decrypted in the previous step 309, whether the address and the duplicated address are identical and whether the corrected data and the duplicated corrected data are identical.

If this is not the case (output N of block 3100), this means that the error correction of the patch code decrypted by circuit BSEC has been modified with respect to the not yet encrypted patch code, available outside system 2. Step 310 is then followed by step 313 (FIG. 3).

Conversely, if this is the case (output Y of block 3100), the method can continue and step 310 can be followed by step 312.

Thus, when step 3100 is implemented, the writing of the patch code into the OTP memory area after decryption by circuit BSEC is conditional on an equality, for each error correction, between the memory address and twice the memory address and between the corrected data and twice the corrected data.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

What is claimed is:

1. A method of loading a patch code into an electronic system comprising a one-time programmable memory area, a first circuit, a first read-only memory having first instructions stored therein, a volatile memory area configured to retain its data on resetting of the system, a first processor, and an external programming port, the method comprising:
in a first state of the system, writing encrypted patch code into the volatile memory area with the external programming port, controlling a switching of the system to a second state at a first next reset, and resetting the system;
in the second state, at a starting of the system, executing the first instructions with the first processor to:
access the volatile memory area to check whether the encrypted patch code is present therein;
switch the system to a third state at a second next reset, and reset of the system in response to the encrypted patch code being absent from the volatile memory area; and
load the encrypted patch code into the first circuit in response to the encrypted patch code being present in the volatile memory area;
in the second state, in response to the loading of the encrypted patch code into the first circuit:
decrypting the encrypted patch code received by the first circuit, with the first circuit and a decryption key stored in the first circuit; and
writing with the first circuit the decrypted patch code into the one-time programmable memory area; and
in the second state, in response to an end of the loading of the decrypted patch code into the one-time programmable memory area, controlling switching of the system to the third state at a third next reset, and resetting the system;
the one-time programmable memory area being programmable only by the first circuit and only in the second state.

2. The method according to claim 1, wherein:
transitioning from the second state to the first state is prohibited;
switching from the third state to any of the first and second states is prohibited;
programming of the volatile memory area with the external programming port is prohibited in the second and third states; and
executing the first instructions is prohibited in the first and third states.

3. The method according to claim 1, wherein the patch code is encrypted outside the system with an encryption key known only to a system manufacturer.

4. The method according to claim 1, wherein:
the encrypted patch code is encapsulated in a structure comprising the encrypted patch code and a first validity code calculated outside the system on the encrypted patch code;
the structure is stored in the volatile memory area on writing of the encrypted patch code into the volatile memory area; and
the loading of the encrypted patch code into the first circuit is conditional on an equality between the first validity code and a second validity code calculated in the system on the encrypted patch code stored in the volatile memory area.

5. The method according to claim 1, wherein:
the encrypted patch code comprises a validity code calculated outside the system on the patch code prior to its encryption; and
at the end of the loading of the decrypted patch code into the one-time programmable memory area, the controlling of the switching of the system to the third state and the resetting of the system are conditional on an equality between the validity code calculated outside the system on the patch code prior to its encryption and a second validity code calculated in the system on the decrypted patch code present in the one-time programmable memory area.

6. The method according to claim 1, wherein the encrypted patch code comprises one or more error corrections, each error correction comprising a memory address and corrected data for replacing erroneous data stored at the memory address.

7. The method according to claim 6, wherein:
for each error correction, the patch code comprises a duplicate of the memory address and a duplicate of the corrected data; and
writing of each error correction into the one-time programmable memory area after the decrypting by the first circuit is conditional on an equality between the memory address and the duplicate of the memory address and between the corrected data and the duplicate of the corrected data.

8. The method according to claim 6, wherein:
the loading of the encrypted patch code into the first circuit is performed error correction by error correction; and
the decrypting of the encrypted patch code with the first circuit comprises, after each reception of an encrypted error correction, decrypting the error correction.

9. The method according to claim 6, wherein the system comprises at least one second processor and at least one second read-only memory.

10. The method according to claim 9, wherein each error correction further comprises an indication of the first or second read-only memory of the system to which the error correction applies.

11. The method according to claim 9, wherein the first processor and the first read-only memory are more secure than the at least one second processor and the at least one second read-only memory, the first instructions being executable only by the first processor.

12. An electronic system comprising:
a one-time programmable memory area;
a volatile memory area configured to retain its data on resetting of the system;
an external programming port configured to writing into the volatile memory area in a first state of the system;
a read-only memory having first instructions stored therein;
a first circuit configured, in response to the system being in a second state and an encrypted patch code being loaded into the first circuit, to decrypt the encrypted patch code, and to write the decrypted patch code into the one-time programming memory area; and
a first processor configured, at a starting of the system in the second state, to read and execute the first instructions, the first instructions being configured to cause an access to the volatile memory area to check whether the encrypted patch code is present therein, and a loading of the encrypted patch code into the first circuit in response to the encrypted patch code being present in the volatile memory area;
wherein the system is configured to:
switch from the second state to a third state after the writing of the decrypted patch code into the one-time programmable memory area; and
switch from the second state to the third state in response to no encrypted patch code being present during the access to the volatile memory area; and
wherein the one-time programmable memory area is programmable only by the first circuit and only in the second state.

13. The electronic system according to claim 12, wherein the system is further configured to:
prohibit switching from the second state to the first state;
prohibit switching from the third state to any of the first and second states;
prohibit programming of the volatile memory area with the external programming port in the second and third states; and
prohibit accessing the first instructions in the first and third states.

14. The electronic system according to claim 12, wherein the encrypted patch code is encrypted outside the system with an encryption key known only to a system manufacturer.

15. The electronic system according to claim 12, wherein:
the encrypted patch code is encapsulated in a structure comprising the encrypted patch code and a first validity code calculated outside the system on the encrypted patch code;
the structure is stored in the volatile memory area on writing of the encrypted patch code into the volatile memory area; and
the loading of the encrypted patch code into the first circuit is conditional on an equality between the first validity code and a second validity code calculated in the system on the encrypted patch code stored in the volatile memory area.

16. The electronic system according to claim 12, wherein:
the encrypted patch code comprises a validity code calculated outside the system on the patch code prior to its encryption; and
at an end of the loading of the decrypted patch code into the one-time programmable memory area, the switch of the system to the third state and the resetting of the system are conditional on an equality between the validity code calculated outside the system on the patch code prior to its encryption and a second validity code calculated in the system on the decrypted patch code present in the one-time programmable memory area.

17. The electronic system according to claim 12, wherein the encrypted patch code comprises one or more error corrections, each error correction comprising a memory address and corrected data for replacing erroneous data stored at the memory address.

18. The electronic system according to claim 17, wherein:
for each error correction, the patch code comprises a duplicate of the memory address and a duplicate of the corrected data; and
writing of each error correction into the one-time programmable memory area after the decrypting by the first circuit is conditional on an equality between the memory address and the duplicate of the memory address and between the corrected data and the duplicate of the corrected data.

19. The electronic system according to claim 17, wherein:
the loading of the encrypted patch code into the first circuit is performed error correction by error correction; and
the decrypting of the encrypted patch code with the first circuit comprises, after each reception of an encrypted error correction, decrypting the error correction.

20. The electronic system according to claim 17, wherein the system comprises at least one second processor and at least one second read-only memory.
